(19) United States
(12) Patent Application Publication
(10) Pub. No.: US 2013/0113721 A1
(43) Pub. Date: May 9, 2013

(54) TOUCH SENSING APPARATUS AND METHOD THEREOF

(71) Applicants: Hyun Suk Lee, Suwon (KR); Yong Il Kwon, Suwon (KR); Tah Joon Park, Suwon (KR)

(72) Inventors: Hyun Suk Lee, Suwon (KR); Yong Il Kwon, Suwon (KR); Tah Joon Park, Suwon (KR)

(73) Assignee: SAMSUNG ELECTRO-MECHANICS CO., LTD., Suwon (KR)

(21) Appl. No.: 13/347,235

(22) Filed: Jan. 10, 2012

(30) Foreign Application Priority Data
Nov. 4, 2011 (KR) 10-2011-0114491

(51) Int. Cl. G06F 3/041

(52) U.S. Cl. 345/173

(57) ABSTRACT

There are provided a touch sensing method and a touch sensing apparatus that can minimize the influence of noise due to a driving signal of a display apparatus. The touch sensing method includes generating an analog signal by sensing variations in capacitance generated from a plurality of electrodes; measuring a first time required for a level of the analog signal to reach a first reference value; determining whether the first time is included in a noise generation period of a driving signal of a display apparatus; and measuring a second time required for a level of the analog signal to reach a second reference value when the first time is included in the noise generation period.

### CROSS-REFERENCE TO RELATED APPLICATIONS

This application claims the priority of Korean Patent Application No. 10-2011-0114491 filed on Nov. 4, 2011, in the Korean Intellectual Property Office, the disclosure of which is incorporated herein by reference.

### BACKGROUND OF THE INVENTION

1. Field of the Invention

The present invention relates to a touch sensing apparatus and a method thereof that can accurately determine whether a touch has been made by minimizing the influence of noise generated in a display apparatus.

2. Description of the Related Art

Touch sensing devices such as a touch screen, a touch pad, and the like, as input devices attached to a display apparatus to provide an intuitive input method to a user, have been widely applied to a variety of electronic apparatuses such as a cellular phone, a personal digital assistant (PDA), a vehicle navigation unit, and the like, in recent years. In particular, recently, with an increase in demand for smart phones, the rate at which touch screens have been adopted as touch sensing device elements capable of providing various input methods in a limited form factor has increased on a day by day basis.

Touch screens adopted in portable apparatuses may be largely classified into resistive type and capacitive type touch screens, according to a touch sensing method. Since the capacitive type touch screen has advantages, in that it may have an extended life-span, and various input methods and gestures can be easily implemented therein, and thus, the adoption rate of the capacitive type touch screen has steadily increased. In particular, it is easier to implement a multi-touch interface in the capacitive type touch screen than in the resistive type touch screen, and as a result, the capacitive type touch screen is widely applied to electronic apparatuses, such as smart phones, and the like.

Touch screens are generally attached to a front surface of the display apparatus, while touch sensing apparatuses other than touch screens are also generally provided within the electronic apparatuses. Accordingly, touch sensing accuracy may be deteriorated due to noise generated in various electronic components, e.g., a wireless communication unit, the display apparatus, and a power supply device, provided together in the electronic apparatus. An additional shielding layer may be provided between the display apparatus and the touch screen in order to solve the problem of noise, but in this case, overall light transmittance may be deteriorated and product thickness may be increased.

### SUMMARY OF THE INVENTION

An aspect of the present invention provides a touch sensing apparatus and a method thereof that can accurately determine a touch by minimizing the influence of noise without an additional shielding layer, by generating an analog signal from a variation in capacitance, measuring times required for the level of the analog signal to reach predetermined reference levels, and converting a time, which is not included in a noise generation period of a driving signal of a display apparatus, into a digital signal by sequentially comparing the level of the analog signals with the plurality of predetermined reference values.

According to an aspect of the present invention, there is provided a touch sensing method, including: generating an analog signal by sensing variations in capacitance generated from a plurality of electrodes; measuring a first time required for a level of the analog signal to reach a first reference value; determining whether the first time is included in a noise generation period of a driving signal of a display apparatus; and measuring a second time required for a level of the analog signal to reach a second reference value when the first time is included in the noise generation period.

The touch sensing method may further include converting the second time into a digital signal.

The touch sensing method may further include converting the first time into a digital signal, when the first time is not included in the noise generation period.

The touch sensing method may further include determining whether the second time is included in the noise generation period, and measuring a third time required for a level of the analog signal to reach a third reference value when the second time is included in the noise generation period.

The touch sensing method may further include converting the third time into a digital signal.

The second time may be longer than the first time.

The noise generation period may correspond to a first half of a period in which the driving signal of the display apparatus has a high signal value.

According to another aspect of the present invention, there is provided a touch sensing apparatus, including: a panel unit including a plurality of sensing electrodes; a sensing circuit unit sensing variations in capacitance generated from the plurality of sensing electrodes to convert the sensed variations in capacitance into an analog signal; and a signal converting unit generating a digital signal by comparing a level of the analog signal with a plurality of reference values having different levels, wherein the signal converting unit sequentially measures times required for the level of the analog signal to reach the plurality of reference values according to the levels of the plurality of reference values, and generates the digital signal from at least one of times which are not included in a noise generation period of a display apparatus, among the measured times.

The signal converting unit may generate the digital signal from the shortest time among the times which are not included in the noise generation period.

The sensing circuit unit may include an integral circuit generating a voltage signal by integrating the variations in capacitance.

The signal converting unit may generate the digital signal by selecting at least one of the measured times when all the measured times are included in the noise generation period.

The sensing circuit unit may sense variations in mutual-capacitances generated among the plurality of sensing electrodes.

According to another aspect of the present invention, there is provided a touch sensing method, including: sensing variations in capacitance generated from a plurality of sensing electrodes; generating an analog signal from the variations in capacitance; sequentially measuring times required for a level of the analog signal to reach a plurality of reference values having different levels according to the levels of the plurality of reference values; and generating a digital signal from at least one of times which are not included in a noise generation period of a display apparatus, among the measured times.

The generating of the analog signal may include generating a voltage signal by integrating the variations in capacitance.

The measuring of the times may include sequentially measuring the times required for the level of the analog signal to reach the plurality of reference values having different voltage levels according to the voltage levels of the plurality of reference values.

The generating of the digital signals may include generating the digital signal by selecting at least one of the measured times when all the measured times are included in the noise generation period.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view illustrating an exterior of an electronic apparatus having a touch sensing apparatus according to an embodiment of the present invention;

FIG. 2 is a plan view illustrating a touch sensing panel electrically connected with a touch sensing apparatus according to an embodiment of the present invention;

FIG. 3 is a cross-sectional view of the touch sensing panel shown in FIG. 2;

FIG. 4 is a block diagram illustrating a touch sensing apparatus according to an embodiment of the present invention;

FIG. 5 is a block diagram illustrating a signal converting unit of a touch sensing apparatus according to an embodiment of the present invention;

FIG. 6 is a graph illustrating an operation of a touch sensing apparatus according to an embodiment of the present invention; and

FIGS. 7 and 8 are flowcharts illustrating a touch sensing method according to an embodiment of the present invention.

### DETAILED DESCRIPTION OF THE INVENTION

Embodiments of the present invention will be described in detail with reference to the accompanying drawings. These embodiments will be described in detail in order to allow those skilled in the art to practice the present invention. It should be appreciated that various embodiments of the present invention are different but are not necessarily exclusive. For example, specific shapes, configurations, and characteristics described in an embodiment of the present invention may be implemented in another embodiment without departing from the spirit and scope of the present invention. In addition, it should be understood that positions and arrangements of individual components in each embodiment may be changed without departing from the spirit and scope of the present invention. Therefore, a detailed description provided below should not be construed as being restrictive. In addition, the scope of the present invention is defined only by the accompanying claims and their equivalents if appropriate. Similar reference numerals will be used to describe the same or similar functions throughout the accompanying drawing.

Hereinafter, embodiments of the present invention will be described in detail with reference to the accompanying drawings so that those skilled in the art may easily practice the present invention.

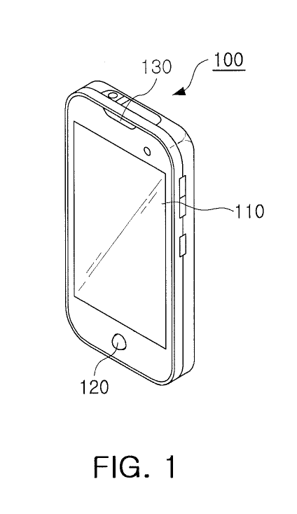

FIG. 1 is a view showing an electronic apparatus to which a touch sensing apparatus according to an embodiment of the present invention is applicable. Referring to FIG. 1, an electronic apparatus 100 according to the present embodiment includes a display apparatus 110 for outputting an image, an input unit 120, an audio unit 130 for outputting audio, and a touch sensing apparatus integrated with the display apparatus 110.

As shown in FIG. 1, in the case of a mobile apparatus, the touch sensing apparatus is generally provided integrally with the display apparatus and needs to have high light transmissivity enough to transmit the image displayed by the display apparatus. Therefore, the touch sensing apparatus may be implemented by forming a sensing electrode using a transparent and electrically conductive material such as indium-tin oxide (ITO), indium zinc oxide (IZO), zinc oxide (ZnO), carbon nano tube (CNT), or graphene, on abase substrate formed of a transparent film material such as polyethylene terephthalate (PET), polycarbonate (PC), polyethersulfone (PES), polyimide (PI), or the like. The display apparatus may include a wiring pattern disposed in a bezel area 115 thereof, and the wiring pattern is connected to the sensing electrode formed of the transparent conductive material. Since the wiring pattern is visually shielded by the bezel area 115, the wiring pattern may be formed of a metallic material such as silver (Ag), copper (Cu), or the like.

In the case in which the touch sensing apparatus according to the embodiment of the present invention may not be provided integrally with the display apparatus like in a touch pad of a notebook computer, the touch sensing apparatus may be manufactured by simply patterning the sensing electrode on a circuit substrate with metal. However, for convenience of explanation, the touch sensing apparatus and method according to the embodiment of the present invention will be described based on the touch screen.

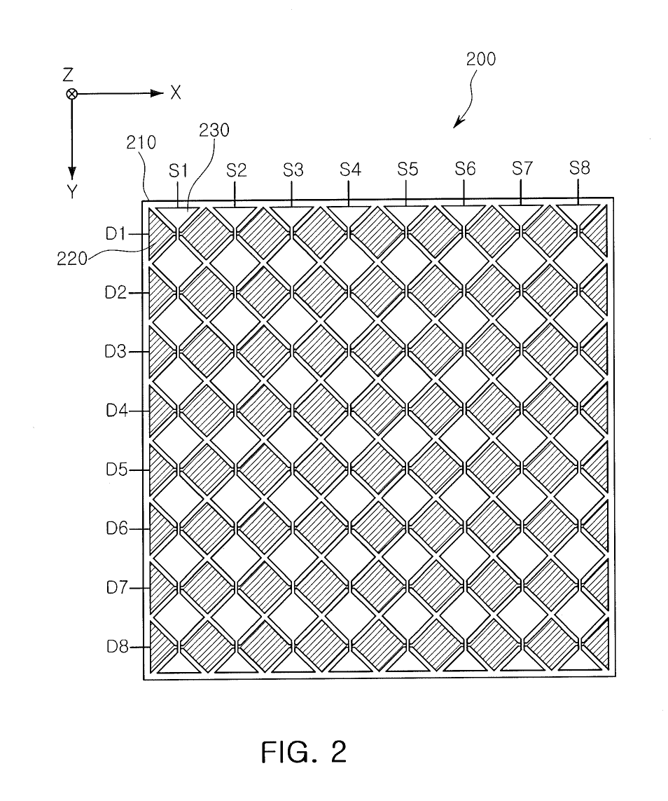

FIG. 2 is a plan view showing a touch sensing panel electrically connected with a touch sensing apparatus according to an embodiment of the present invention.

Referring to FIG. 2, a touch sensing panel 200 according to this embodiment includes a substrate 210 and a plurality of sensing electrodes 220 and 230 provided on the substrate 210. Although not shown in FIG. 2, each of the plurality of sensing electrodes 220 and 230 may be electrically connected with the wiring pattern of the circuit board attached to one end of the substrate 210 through a wire and a bonding pad. A controller integrated circuit is mounted on the circuit board to detect sensed signals generated from the plurality of sensing electrodes 220 and 230 and determine the touch based thereon.

In the touch screen apparatus, the substrate 210 may be a transparent substrate in which the sensing electrodes 220 and 230 can be formed, and may be formed of a plastic material such as polyimide (PI), polymethylmethacrylate (PMMA), polyethyleneterephthalate (PET), or polycarbonate (PC) or tempered glass. Further, apart from an area in which the sensing electrodes 220 and 230 are formed, a predetermined printing area for the wire connected with the sensing electrodes 220 and 230 may be formed on the substrate 210 in order to visually shield the wire formed of an opaque metallic material.

The plurality of sensing electrodes 220 and 230 may be provided on one surface or both surfaces of the substrate 210. In the case of the touch screen apparatus, the plurality of sensing electrodes 220 and 230 may be formed of a transparent conductive material such as indium-tin oxide (ITO), indium zinc-oxide (IZO), zinc oxide (ZnO), carbon nano tube (CNT), or grapheme based material. Although the sensing electrodes 220 and 230 having a rhombus or diamond-shaped pattern are shown in FIG. 2, the sensing electrodes 220 and 230 may have various patterns using polygonal shapes such as a rectangle, a triangle, and the like.

The plurality of sensing electrodes 220 and 230 include first electrodes 220 extending in an X-axis direction and second electrodes 230 extending in a Y-axis direction. The first electrodes 220 and the second electrodes 230 may be provided on both surfaces of the substrate 210 or provided on different substrates to intersect each other. In the case in which both the first and second electrodes 220 and 230 are provided on one surface of the substrate 210, a predetermined insulating layer may be partially formed at an intersecting point between the first and second electrodes 220 and 230.

A touch sensing apparatus that is electrically connected with the plurality of sensing electrodes 220 and 230 to sense a touch detects capacitive variations sensed in the plurality of sensing electrodes 220 and 230 and senses the touch therefrom. The first electrodes 220 are connected to channels defined as D1 to D8 in the controller integrated circuit to receive predetermined driving signals, and the second electrodes 230 are connected to channels defined as S1 to S8 to be used in order for the controller integrated circuit to detect sensed signals. In this case, the controller integrated circuit may detect mutual-capacitance variations generated between the first and second electrodes 220 and 230 as the sensed signals, and may sequentially apply the driving signals to the individual first electrodes 220 and simultaneously detect capacitance variations from the second electrodes 230.

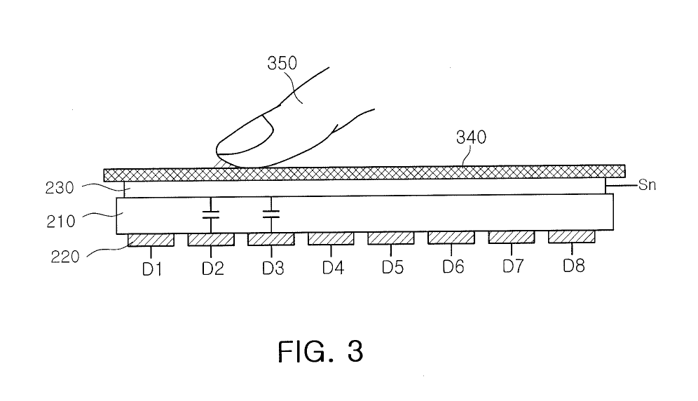

FIG. 3 is a cross-sectional view of the touch sensing panel shown in FIG. 2.

FIG. 3 is a cross-sectional view of the touch sensing panel 200 shown in FIG.2 taken in a Y-Z direction. The touch sensing panel 200 may further include a cover lens 340 receiving the touch, in addition to the substrate 210 and the plurality of sensing electrodes 220 and 230 described in FIG. 2. The cover lens 340 is provided on the second electrodes 330 used to detect the sensed signals such that it may receive the touch from a touching object 350 such as a finger.

When the driving signals are sequentially applied to the first electrodes 220 through the channels D1 to D8, mutual-capacitance is generated between the first and second electrodes 220 and 230. When the driving signals are sequentially applied to the first electrodes 220, a capacitance variation may occur between the first and second electrodes 220 and 230 adjacent to an area contacted by the touching object 350. The capacitance variation may be proportionate to a dimension of an area overlapped among the touching object 350, the first electrodes 220 applied with the driving signals and the second electrodes 230. In FIG. 3, the mutual-capacitance generated between the first and second electrodes 220 and 230 connected to the channels D2 and D3 is influenced by the touching object 350.

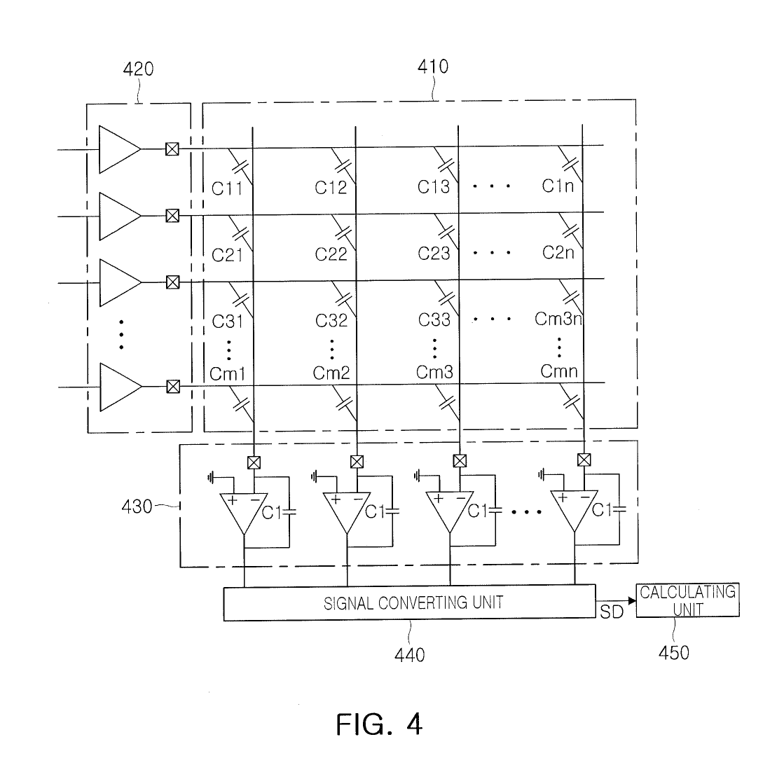

FIG. 4 is a block diagram of a touch sensing apparatus according to an embodiment of the present invention.

Referring to FIG. 4, a touch sensing apparatus according to the present embodiment includes a panel unit 410, a driving circuit unit 420, a sensing circuit unit 430, a signal converting unit 440, and a calculating unit 450. The panel unit 410 includes a plurality of first electrodes extending in a first axis direction (a horizontal direction of FIG. 4) and a plurality of second electrodes extending in a second axis direction intersecting the first axis direction (a vertical direction of FIG. 4). Variations in capacitance C11 to Cmn are generated at intersecting points between the first and second electrodes. The variations in capacitance C11 to Cmn generated at the intersections of the first and second electrodes may be variations in mutual-capacitance generated by driving signals applied to the first electrodes by the driving circuit unit 420. Meanwhile, the driving circuit unit 420, the sensing circuit unit 430, the signal converting unit 440, and the calculating unit 450 may be configured as an integrated circuit (IC).

The driving circuit unit 420 applies predetermined driving signals to the first electrodes of the panel unit 410. The driving signals may have a square wave, a sine wave, a triangle wave, and the like having a predetermined cycle and a predetermined amplitude. The driving signals may be sequentially applied to the plurality of first electrodes, respectively. As shown in FIG. 4, the circuits for generating and applying the driving signals to the first electrodes are individually connected to the plurality of respective first electrodes. However, a single driving signal generating circuit may be used together with a switching circuit such that it may apply the driving signals to the plurality of first electrodes through the switching circuit.

The sensing circuit unit 430 may include integral circuits for sensing the variations in capacitance C11 to Cmn from the second electrodes. The integral circuit may include at least one operational amplifier and a capacitor C1 having a predetermined capacitance. An inversion input terminal of the operational amplifier is connected to the second electrode to convert the variations in capacitance C11 to Cmn to analog signals such as voltage signals and output the signals. When the driving signals are sequentially applied to the plurality of first electrodes, respectively, the variations in capacitance may be simultaneously detected from the plurality of second electrodes, and thus, the number of integral circuits may correspond to the number (m) of the second electrodes.

The signal converting unit 440 generates a digital signal S_{D} from the analog signal generated by the integral circuit. For example, the signal converting unit 440 may include a time-to-digital converter (TDC) circuit measuring a time required for a voltage type analog signal outputted from the sensing circuit unit 430 to reach a predetermined reference voltage level and converting the measured time into a digital signal S_{D}, or an analog-to-digital converter (ADC) circuit measuring a variation in a level of an analog signal outputted from the sensing circuit unit 430 for a predetermined time and converting the measured variation into a digital signal S_{D}. The calculating unit 450 determines the touch applied to the panel unit 410 by using the digital signal S_{D}. For example, the calculating unit 450 may determine the number of touches applied to the panel unit 410, coordinates of the touch, movements during the touch, and the like.

In general, the panel unit 410 is integrally provided in the upper part of the display apparatus, and as a result, the panel unit 410 is influenced by electric noise generated in the display apparatus. On the assumption that the touch sensing apparatus of FIG. 4 is applied to a mobile electronic apparatus, the display apparatus may be generally assumed as an LCD or an OLED. A flat panel display apparatus such as an LCD or an OLED has a lattice structure intersecting in horizontal and vertical directions and may include agate driver circuit and a data driver circuit for applying signals to implement an image in pixels present at intersections. In this case, a driving signal of the display apparatus has a predetermined cycle and a predetermined amplitude similar to that of a driving signal of the touch sensing apparatus. Electric noise generated while the driving signal of the display apparatus is applied to each pixel of the display apparatus may have a bad influence on the performance of the touch sensing apparatus.

In particular, in the case in which the signal converting unit 440 includes the TDC circuit to generate the digital signal S_{D} from the time required for the level of the analog signal outputted from the sensing circuit unit 430 to reach a predetermined reference level, when the time required for the level of the analog signal to reach the reference level is included in a noise generation period in which noise is transferred by the driving signal of the display apparatus, it is difficult to accurately generate the digital signal S_{D}. Since it is difficult for the TDC circuit to implement a sample-and-hold function unlike the ADC circuit, it is also difficult to adopt a method of measuring the time by avoiding the noise generation period.

In this embodiment of the present invention, in order to reduce the influence of noise when the time measured by the signal converting unit 440 is included in the noise generation period of the driving signal of the display apparatus, a plurality of reference levels are set, such that they may serve as references for the signal converting unit 440 to convert the analog signal into the digital signal. That is, a plurality of reference values having different levels are set, and the level of the analog signal which is integrated in the integral circuit of the sensing circuit unit 430 to be increased according to the times is compared with the plurality of reference values in ascending order.

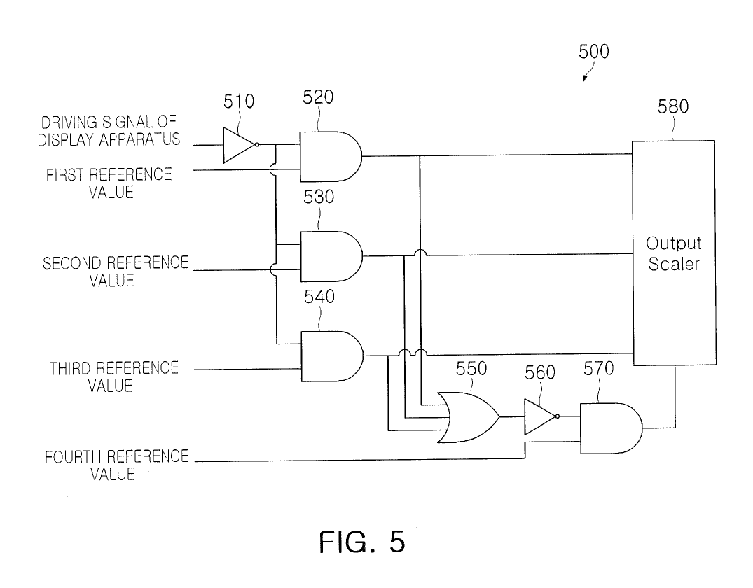

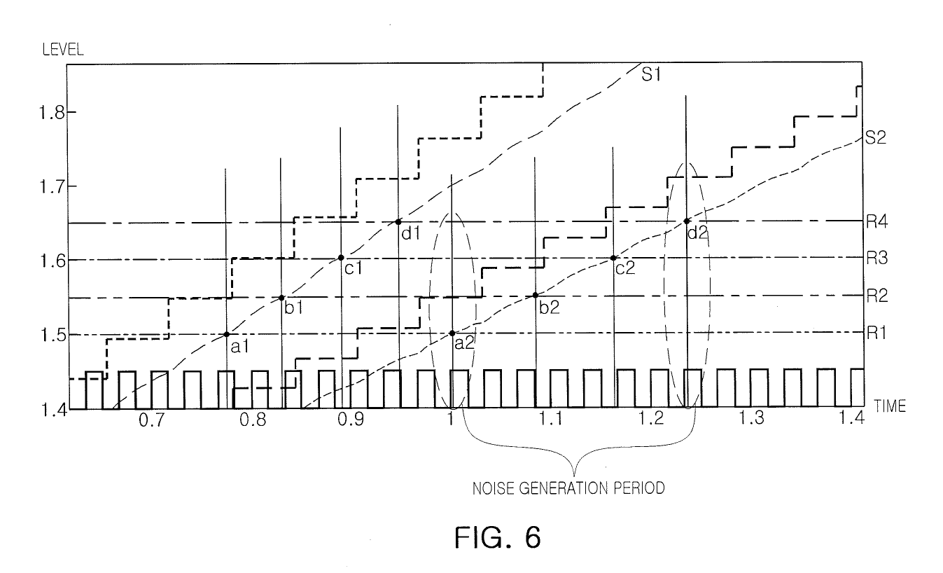

When a time (hereinafter, referred to as a first time) required for the level of the analog signal to reach a reference value (hereinafter, referred to as a first reference value) having the lowest level is not included in the noise generation period, the signal converting unit 440 converts the first time to the digital signal. On the contrary, when it is determined that the first time at which the level of the analog signal reaches the first reference value is included in the noise generation period, the signal converting unit 440 measures a second time at which the level of the analog signal reaches a second reference value having a higher level than that of the first reference value, and determines whether the second time is included in the noise generation period to generate the digital signal. Hereinafter, referring to FIGS. 5 and 6, the signal converting unit will be described in more detail.

FIG. 5 is a block diagram illustrating a signal converting unit of a touch sensing apparatus according to an embodiment of the present invention, and FIG. 6 is a graph illustrating an operation of a touch sensing apparatus according to an embodiment of the present invention.

First, referring to FIG. 5, a signal converting unit 500 receives first to fourth reference values having different levels in addition to the driving signal of the display apparatus. The driving signal of the display apparatus, together with the first reference value, may be input into an input terminal of a first logic gate 520 (an AND gate in FIG. 5) through a buffer 510.

An output scaler 580 included in the signal converting unit 500 compares the first to fourth reference values with the driving signal of the display apparatus to determine a reference value to be used in signal conversion. First, the first logic gate 520 receives the driving signal of the display apparatus and the first reference value and transmits an AND-operation result of the driving signal of the display apparatus and the first reference value to the output scaler 580. Likewise, the AND-operation results between the driving signal of the display apparatus and the second and third reference values are acquired by second and third logic gates 530 and 540 and transmitted to the output scaler 580.

A fourth logic gate 550 may be implemented as an OR operator unlike the first to third logic gates 520, 530, and 540. The fourth logic gate 550 receives all the output signals of the first to third logic gates 520, 530, and 540 to generate an output signal. That is, when the output signals of the first to third logic gates 520, 530, and 540 have low signal values, the output signal of the fourth logic gate 550 has a low signal value and is then input as a high signal value into a fifth logic gate 570 through a buffer 560. Therefore, when all the AND-operation values of the first to third reference values and the driving signal of the display apparatus are 0, that is, when the times required to convert the analog signal into the digital signal according to the first to third reference values are included in the noise generation period, a time required for the level of the analog signal to reach the fourth reference value is measured, regardless of whether the fourth reference value is included in the noise generation period, and the digital signal is generated based thereon.

Referring to FIG. 6, the graph shows signal levels according to times, and first to fourth reference values R1 to R4 are defined as different levels. A first analog signal S1 corresponding to a first capacitance variation shows a signal level increasing steadily as time goes by and has intersections of a1, b1, c1, and d1 with the first to fourth reference values R1 to R4.

In order to convert the analog signal S1 into the digital signal, the signal converting unit 500 selects the first reference value R1 and determines whether a time a1 at which the first reference value R1 and the analog signal S1 intersect is included in the noise generation period. Referring to FIG. 6, the time a1 is included in a period in which the driving signal of the display apparatus indicated as a clock signal has a high signal value. Therefore, the signal converting unit 500 determines that the time a1 is included in the noise generation period and a time b1 at which the second reference value R2 and the analog signal S1 intersect is measured to convert the measured time b1 into the digital signal. As shown in FIG. 6, since the time b1 corresponds to a period in which the driving signal of the display apparatus has a low signal value, it may be determined that the time b1 is not included in the noise generation period.

Alternatively, although the time a1 is included in the period in which the driving signal of the display apparatus has the high signal value, it may be determined that the time a1 is not included in the noise generation period. Electric noise is concentrically generated within the period in which the driving signal of the display apparatus has the high signal value, in particular, within a first half of the period. Accordingly, when the time a1 is not included in the first half of the period, even when the time a1 is included in the period in which the driving signal of the display apparatus has the high signal value, it is determined that the time a1 is not affected by noise so that the time a1 may be converted into the digital signal.

Next, a time a2 at which a level of a second analog signal S2 intersects with the first reference value R1 is included in the first half of the period in which the driving signal of the display apparatus has the high signal value. Therefore, as shown in FIG. 6, it may be determined that the time a2 is included in the noise generation period, and the signal converting unit 500 selects the second reference value R2 subsequent to the first reference value R1 to determine whether a time b2 required for the analog signal S2 to reach the second reference value R2 is included in the noise generation period. As shown in FIG. 6, since the time b2 at which the second reference value R2 and the level of the analog signal S2 intersect is included in the period in which the driving signal of the display apparatus has the low signal value, that is, the period in which noise is not generated, the signal converting unit 500 may generate the digital signal from the time b2. As shown in FIG. 6, in the case of the analog signal S2, the time a2 and a time d2 required for the level of the analog signal S2 to reach the first reference value R1 and the fourth reference value R4, respectively, are included in the noise generation period.

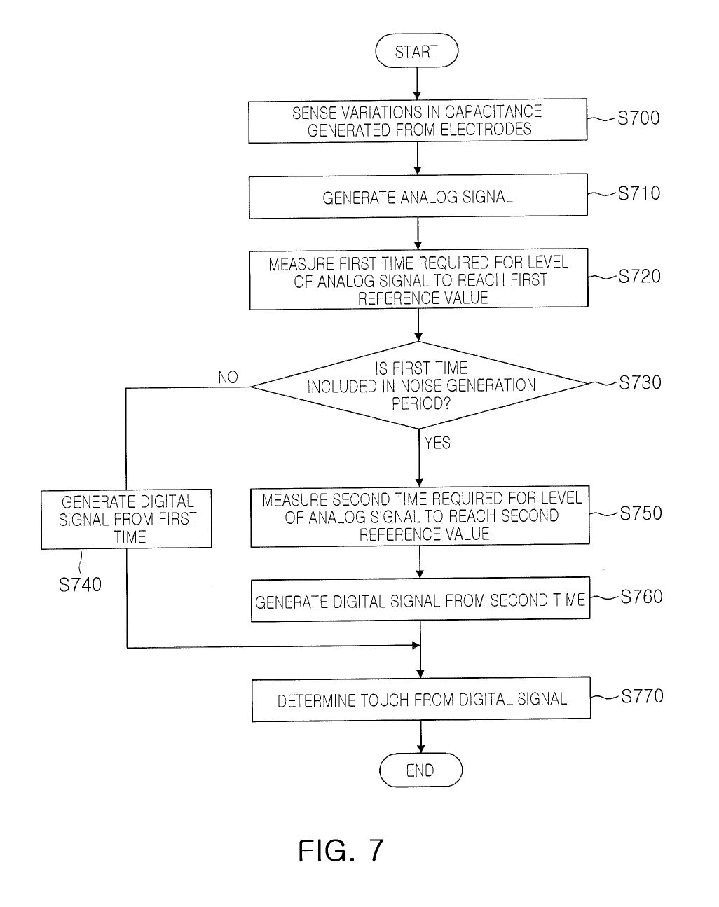

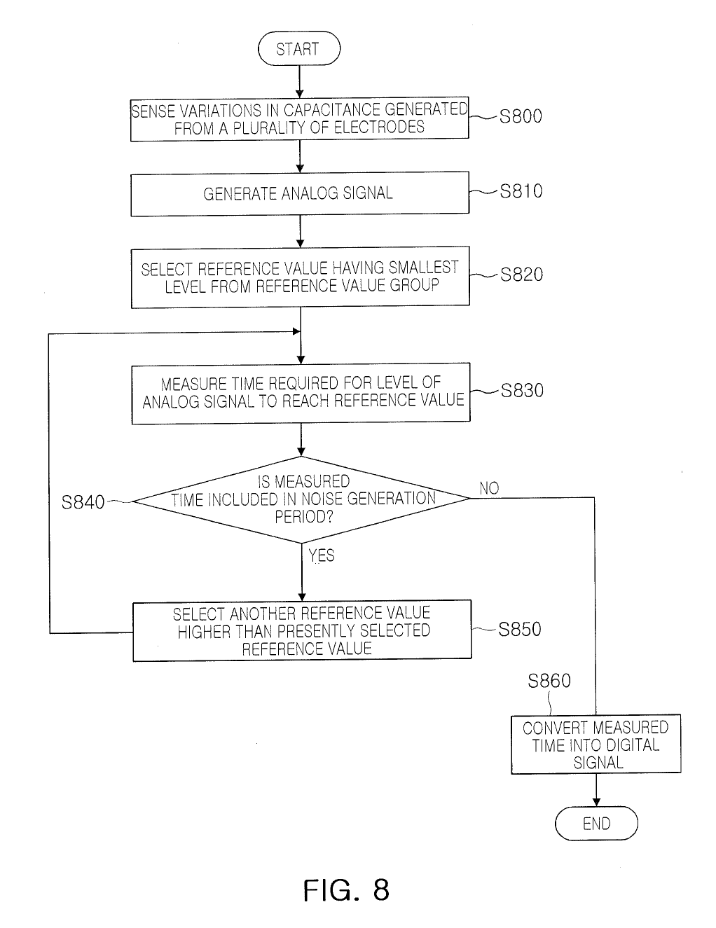

FIGS. 7 and 8 are flowcharts illustrating a touch sensing method according to an embodiment of the present invention.

First, referring to FIG. 7, a touch sensing method according to an embodiment of the invention is initiated with sensing variations in capacitance generated in electrodes (S700). As described above, the integral circuit included in the sensing circuit unit 430 may generate an analog signal such as a voltage signal from variations in mutual-capacitance C11 to Cmn generated between the electrodes of the panel unit 410 (S710).

The signal converting unit 440 connected with the sensing circuit unit 430 measures a first time required for the level of the analog signal to reach a first reference value (S720). In operation S720, the signal converting unit 440 may measure the first time a1 or a2 required for the level of the analog signal S1 or S2 to reach the first reference value R1 as shown in the graph of FIG. 6. When the first time a1 or a2 is measured, it is determined whether the measured first time a1 or a2 is included in a noise generation period (S730).

Here, the noise generation period compared with the first time a1 or a2 maybe defined as the period in which a driving signal of the display apparatus has a high signal value or a first half of the period. When the noise generation period is defined as the period in which the driving signal has the high signal value, it is determined that both the first times a1 and a2 of the analog signals S1 and S2 are included in the noise generation period. When the noise generation period is defined as the first half of the period in which the driving signal has the high signal value, it is determined that only the first time a2 of the analog signal S2 is included in the noise generation period in FIG. 6. Hereinafter, for convenience of explanation, it is assumed that the noise generation period is defined as the first half of the period in which the driving signal of the display apparatus has the high signal value.

According to the determination result of S730, when it is determined that the first time a1 is not included in the noise generation period, the digital signal is generated from the first time a1 (S740). According to the determination result of S730, when it is determined that the first time a2 is included in the noise generation period, a second time b2 required for the level of the analog signal S2 to reach the second reference value R2 is measured (S750) and the digital signal is generated from the second time b2 (S760). The calculating unit 450 may determine a touch from the digital signal.

The flowchart of FIG. 7 shows a case in which a predetermined reference value includes only the first and second reference values R1 and R2. Therefore, when the time a1 or a2 required for the level of the analog signal to reach the first reference value R1 is included in the noise generation period, the digital signal may be generated from the second time b1 or b2.

Referring to the flowchart of FIG. 8, the touch sensing method is also initiated with sensing variations in capacitance generated in a plurality of electrodes (S800). Similar to the embodiment of FIG. 7, the integral circuit of the sensing circuit unit 430 may sense the variations in mutual-capacitance generated at the intersections of the plurality of electrodes included in the panel unit 410. The integral circuit integrates the variations in capacitance to generate an analog signal such as a voltage signal (S810).

When the sensing circuit unit 430 generates the analog signal, the signal converting unit 440 selects a reference value to be compared with the analog signal from a predetermined reference value group (S820). The reference value group may include a plurality of reference values R1 to R4 having different levels and the signal converting unit 440 first selects a reference value having the lowest level as the first reference value R1. This is intended to shorten the measured time in order to generate the digital signal as shown in the graph of FIG. 6.

When the first reference value R1 is selected, the signal converting unit 440 measures a time required for the level of the analog signal to reach the level of the first reference value R1 (S830) and it is determined whether the time measured in operation S830, that is, the first time a1 or a2 of FIG. 6 is included in the noise generation period of the driving signal of the display apparatus (S840). In operation S840, when it is determined that the measured first time a1 or a2 is included in the noise generation period, the signal converting unit 440 selects another reference value having a higher level than that of the first reference value R1.

Referring to FIG. 6, the second reference value R2 having the next smallest level to the first reference value R1 may be selected as a new reference value.

When the second reference value R2 is newly selected, a time required for the level of the analog signal to reach the second reference value R2, that is, the second time b1 or b2 is measured (S830) and it is determined whether the second time b1 or b2 is included in the noise generation period (S840). When it is determined that the second time b1 or b2 is also included in the noise generation period, the third reference value R3 having the higher level is selected to reperform operations S830 and S840.

Finally, when it is determined that the time measured with reference to the presently selected reference value is not included in the noise generation period in operation S840, the signal converting unit 440 converts the measured time into the digital signal (S860). Even in the case that the measured time with reference to the presently selected reference value is included in the noise generation period, when no selectable reference value remains, the digital signal may be generated from the time measured according to the finally selected reference value as described in FIG. 7.

As set forth above, according to the embodiments of the present invention, in order to covert an analog signal into a digital signal by measuring a time required for a level of the analog signal to reach a predetermined reference value, a plurality of reference values are set in advance and the digital signal is generated from the measured time which is not included in a noise generation period of a driving signal of a display apparatus. Accordingly, the influence of noise generated in the display apparatus may be minimized without an additional shielding layer, so that a touch sensing operation may be accurately performed.

While the present invention has been shown and described in connection with the embodiments, it will be apparent to those skilled in the art that modifications and variations can be made without departing from the spirit and scope of the invention as defined by the appended claims.

What is claimed is:

1. A touch sensing method, comprising:
generating an analog signal by sensing variations in capacitance generated from a plurality of electrodes;
measuring a first time required for a level of the analog signal to reach a first reference value;
determining whether the first time is included in a noise generation period of a driving signal of a display apparatus; and
measuring a second time required for a level of the analog signal to reach a second reference value when the first time is included in the noise generation period.

2. The touch sensing method of claim 1, further comprising converting the second time into a digital signal.

3. The touch sensing method of claim 1, further comprising converting the first time into a digital signal, when the first time is not included in the noise generation period.

4. The touch sensing method of claim 1, further comprising:
determining whether the second time is included in the noise generation period; and
measuring a third time required for a level of the analog signal to reach a third reference value when the second time is included in the noise generation period.

5. The touch sensing method of claim 4, further comprising converting the third time into a digital signal.

6. The touch sensing method of claim 1, wherein the second time is longer than the first time.

7. The touch sensing method of claim 1, wherein the noise generation period corresponds to a first half of a period in which the driving signal of the display apparatus has a high signal value.

8. A touch sensing apparatus, comprising:
a panel unit including a plurality of sensing electrodes;
a sensing circuit unit sensing variations in capacitance generated from the plurality of sensing electrodes to convert the sensed variations in capacitance into an analog signal; and
a signal converting unit generating a digital signal by comparing a level of the analog signal with a plurality of reference values having different levels,
wherein the signal converting unit sequentially measures times required for the level of the analog signal to reach the plurality of reference values according to the levels of the plurality of reference values, and generates the digital signal from at least one of times which are not included in a noise generation period of a display apparatus, among the measured times.

9. The touch sensing apparatus of claim 8, wherein the signal converting unit generates the digital signal from the shortest time among the times which are not included in the noise generation period.

10. The touch sensing apparatus of claim 8, wherein the sensing circuit unit includes an integral circuit generating a voltage signal by integrating the variations in capacitance.

11. The touch sensing apparatus of claim 8, wherein the signal converting unit generates the digital signal by selecting at least one of the measured times when all the measured times are included in the noise generation period.

12. The touch sensing apparatus of claim 8, wherein the sensing circuit unit senses variations in mutual-capacitances generated among the plurality of sensing electrodes.

13. A touch sensing method, comprising:
sensing variations in capacitance generated from a plurality of sensing electrodes;
generating an analog signal from the variations in capacitance;
sequentially measuring times required for a level of the analog signal to reach a plurality of reference values having different levels according to the levels of the plurality of reference values; and
generating a digital signal from at least one of times which are not included in a noise generation period of a display apparatus, among the measured times.

14. The touch sensing method of claim 13, wherein the generating of the analog signal includes generating a voltage signal by integrating the variations in capacitance.

15. The touch sensing method of claim 14, wherein the measuring of the times includes sequentially measuring the times required for the level of the analog signal to reach the plurality of reference values having different voltage levels according to the voltage levels of the plurality of reference values.

16. The touch sensing method of claim 13, wherein the generating of the digital signals includes generating the digital signal by selecting at least one of the measured times when all the measured times are included in the noise generation period.
